(19) United States
(12) Patent Application Publication
(10) Pub. No.: US 2008/0220655 A1
(43) Pub. Date: Sep. 11, 2008

(54) Electrical connector with improved retention structures

(75) Inventors: Fang-Chu Liao, Tu-cheng (TW); Shuo-Hsiu Hsu, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/075,152

(22) Filed: Mar. 10, 2008

(30) Foreign Application Priority Data
Mar. 9, 2007 (CN) 200720035281.X

(51) Int. Cl. H01R 12/04

(52) U.S. Cl. 439/629

(57) ABSTRACT

An electrical connector (100) for electrically connecting with a chip module and a printed circuit board comprises a plurality of insulative housings (1), a plurality of contacts received in the insulative housing, and a frame (2) defining an accommodating space (26) to accommodate the insulative housings. The frame defines continuous lateral walls (23) and a plurality of enhancing ribs (24) extending from the lateral walls into the accommodating space. A plurality of first rivet sections (231) are disposed on at least one of the lateral walls of the frame and the insulative housings and a plurality of first mounting holes (16) are defined in at least one of the insulative housings and the lateral walls of the frame to receive the first rivet sections. A plurality of second rivet sections (243) are disposed on at least one of the enhancing ribs of the frame and the insulative housings and a plurality of second mounting holes (17) are defined in at least one of the insulative housings and the enhancing ribs to receive the rivet sections.

### BACKGROUND OF THE INVENTION

1. Field of the Invention

The present invention generally relates to an electrical connector, and more particularly to an electrical connector for removably mounting a chip module to a printed circuit board.

2. Description of Related Art

Electrical connectors are widely used in computer field to realize electrical connections between chip modules and printed circuit boards because of their stable performance.

Such an electrical connector usually comprises a molded insulative housing and a plurality of contacts accommodated in the insulative housing. The insulative housing comprises opposite mating surface and mounting surface. When the electrical connector is in use, the insulative housing is firstly retained to the printed circuit board via soldering solder balls of the contacts to the printed circuit board, then the chip module is positioned to the mating surface to realize electrical contact between mating portions of the contacts and electrical pads of the chip module in one-by-one manner. Thus, the electrical connection between the chip module and the printed circuit board is realized.

However, with the development of technologies, new challenge of more stable electrical connection and higher speed of data transmission to the conventional connectors are raised. Thus, a conventional electrical connector was designed to electrically connect the chip module and the printed circuit board. The conventional electrical connector comprises a plurality of insulative housings, a plurality of contacts retained in the insulative housings and a frame capable of being riveted to the insulative housings. The frame comprises sidewalls each forming a transverse-bar retention rib extending into the frame to divide the frame into a plurality of receiving sections. Each sidewall forms a plurality of rivet sections, correspondingly, the insulative housing forms a plurality of through holes. To assemble the insulative housings to the frame, the rivet sections protrude through the through holes then are riveted by tool and become thinner and larger to contact upper surfaces of the insulative housings to retain the housings to the frame.

However, the frame only disposes rivet sections on sidewalls, the retention rib is of transverse bar shape. Limited by limited space of the retention ribs, the rivet sections cannot be disposed on the retention ribs. Therefore, the rivet sections are only disposed on the sidewalls of the frame, the insulative housings still have possibility to separate from the frame. Therefore, it is desired to provide an improved electrical connector to stress the problems mentioned above.

### BRIEF SUMMARY OF THE INVENTION

Accordingly, an object of the present invention is to provide an electrical connector with improved retention structures for retaining a plurality of insulative housings together.

In order to achieve the above-mentioned object, an electrical connector for electrically connecting with a chip module and a printed circuit board comprises a plurality of insulative housings, a plurality of contacts received in the insulative housing, and a frame defining an accommodating space to accommodate the insulative housings. The frame defines continuous lateral walls and a plurality of enhancing ribs extending from the lateral walls into the accommodating space. A plurality of first rivet sections are disposed on at least one of the lateral walls of the frame and the insulative housings and a plurality of first mounting holes are defined in at least one of the insulative housings and the lateral walls of the frame to receive the first rivet sections. A plurality of second rivet sections are disposed on at least one of the enhancing ribs of the frame and the insulative housings and a plurality of second mounting holes are defined in at least one of the insulative housings and the enhancing ribs to receive the rivet sections.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a partially, exploded perspective view of an electrical connector in accordance with the present invention;

FIG. 2 is an enlarged, perspective view of an insulative housing of the electrical connector shown in FIG. 1; and

FIG. 3 is a top, assembled view of the electrical connector.

### DETAILED DESCRIPTION OF THE INVENTION

Reference will now be made to the drawing figures to describe the present invention in detail.

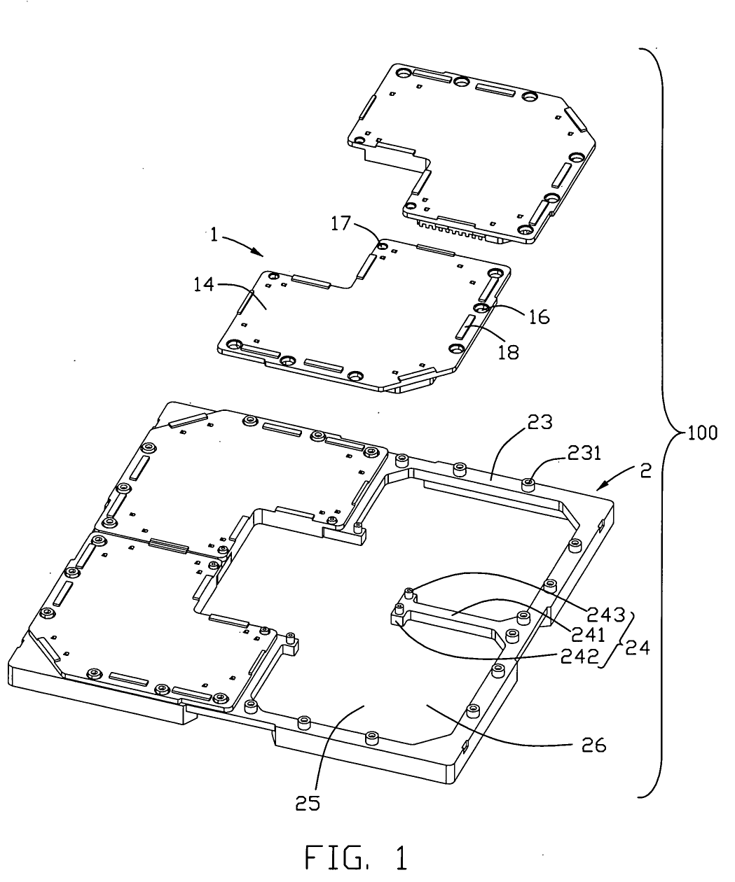

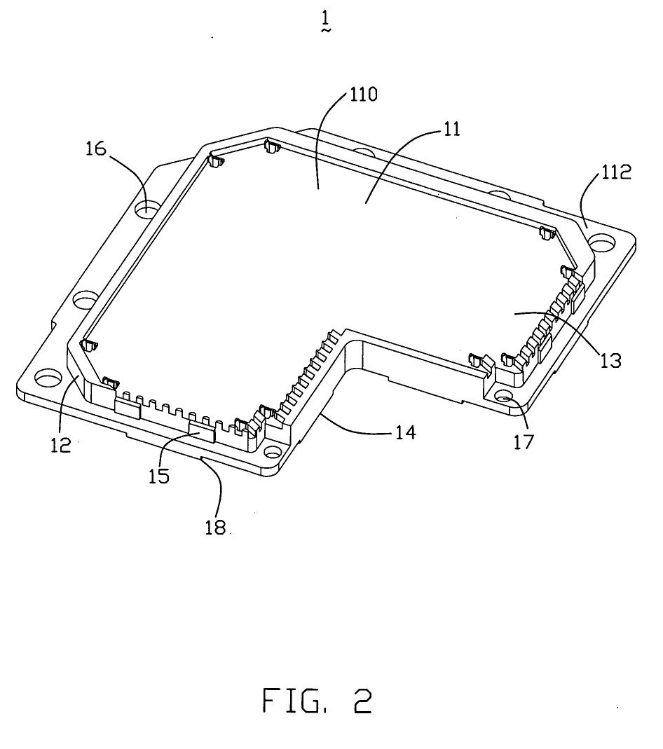

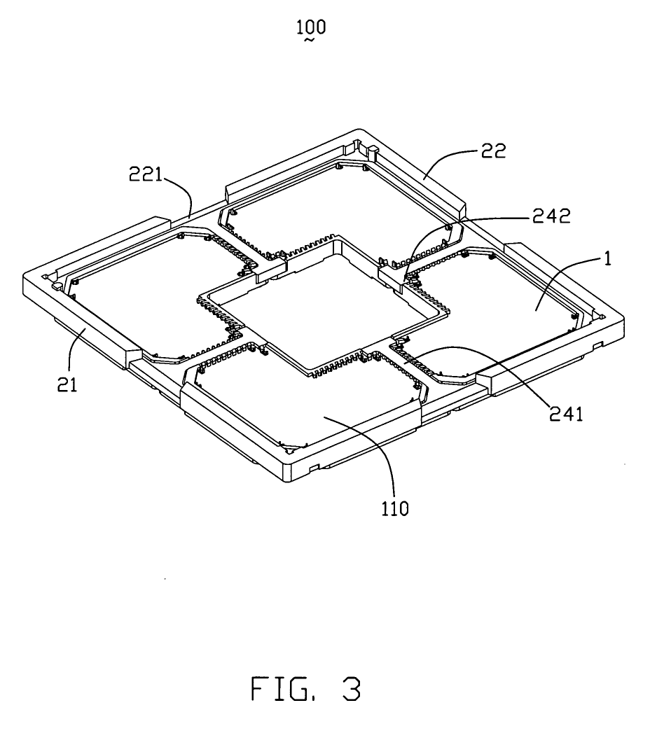

Please refer to FIGS. 1-3, an electrical connector 100 in accordance with the present invention for electrically connecting a chip module (not shown) to a printed circuit board (PCB, not shown) comprises four insulative housings 1, a plurality of contacts (not shown) received in the insulative housings 1, and a frame 2 riveted to the insulative housing 1.

The insulative housing 1 is of L-shape and comprises a bottom main portion 11, a plurality of vertical sidewalls 12 extending upwardly from the main portion 11 to form an inner space 110 for accommodating the chip module and outer flat side edges 112. The main portion 11 defines a supporting surface 13 supporting the chip module, a mounting surface 14 opposite to the supporting surface 13 for being mounted to the PCB, and a plurality of contact-receiving slots (not labeled) extending through the main portion 11 from the supporting surface 13 to the mounting surface 14 to be in matrix manner. A plurality of tubers 15 are arranged on outer periphery of the sidewalls 12 for interferentially engaging with inner periphery of lateral walls 21 of the frame 2. A plurality of first mounting holes 16 and second mounting holes 17 are defined through the side edges 112 and spaced arranged or cooperating with the frame 2. A standoff 18 is formed on the mounting surface 14 of the insulative housing 1 and located between two adjacent first mounting holes 16 to form clearance between the insulative housing 1 and the PCB for convenient solder.

The frame 2 is a rectangular block and comprises continuous lateral walls 21. Four edge-shape cutouts 221 are recessed downwardly from upper surfaces of the lateral walls 21 for picking up the chip module conveniently. A plurality of column-shape first rivet sections 231 protrude downwardly from lower surfaces of the lateral walls 21 and spaced arranged corresponding to the first mounting holes 16. A T-shape enhancing rib 24 extends from a middle of an inner edge of one lateral wall 21 toward opposite lateral wall 21 a certain distance and forms an enlarged transverse section 242 at free end thereof. Thus, a large accommodating space 26 is divided into four non-close accommodating section 25 for accommodating the four insulative housing 1. A pair of second rivet sections 243 depends downwardly from the transverse section 242 according to the second mounting holes 17. The outer diameter of each first rivet section 231 is larger than that of the second rivet section 242. Correspondingly, the diameter of the first mounting hole 16 is larger than that of the second mounting hole 17.

In assembly, the four insulative housings 1 accommodated with contacts are assembled into the accommodating sections 25 from bottom of the frame 2. The tubers 15 interferentially engage with inner periphery of the lateral walls 21, the enlarged transverse sections 242 press on the side edges 112 with the second rivet sections 243 protruding into the second mounting holes 17 and the first rivet sections 231 protruding into the first mounting holes 16. Under rivet forces exerted by tool, the first and second rivet sections 231, 243 are deformed and abut against the mounting surfaces 14 of the insulative housings 1 to form reliable interconnection between the insulative housings 1 and the frame 2.

In alternative embodiments, the rivet sections 231, 243 can be disposed on the insulative housings 1, while the mounting holes 16, 17 can be disposed in the frame 2.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector adapted for electrically connecting with a chip module and a printed circuit board, comprising:
a plurality of insulative housings;
a plurality of contacts received in the insulative housing; and
a frame defining an accommodating space to accommodate the insulative housings, the frame defining continuous lateral walls and a plurality of enhancing ribs extending from the lateral walls into the accommodating space; and wherein
a plurality of first rivet sections are disposed on at least one of the lateral walls of the frame and the insulative housings and a plurality of first mounting holes are defined in at least one of the insulative housings and the lateral walls of the frame to receive the first rivet sections; and wherein
a plurality of second rivet sections are disposed on at least one of the enhancing ribs of the frame and the insulative housings and a plurality of second mounting holes are defined in at least one of the insulative housings and the enhancing ribs to receive the rivet sections.

2. The electrical connector as claimed in claim 1, wherein each enhancing rib of the frame forms a pair of rivet sections riveted to connect with two different insulative housings.

3. The electrical connector as claimed in claim 1, wherein the electrical connector comprises four insulative housings, and wherein each insulative housing forms outer side edges standing on the lateral walls and the enhancing ribs.

4. The electrical connector as claimed in claim 3, wherein the side edges of the insulative housing defines a plurality of first and second mounting holes with different diameters, and wherein the lateral walls and the enhancing ribs forms a plurality of first and second rivet sections to engage with the first and second mounting holes, respectively.

5. The electrical connector as claimed in claim 3, wherein each insulative housing is of L-shape and cooperates with two lateral walls of the frame and two enhancing ribs of the frame.

6. The electrical connector as claimed in claim 5, wherein a central opening is circumscribed by the L-shape insulative housings.

7. The electrical connector as claimed in claim 1, wherein each enhancing rib is of T-shape and forms a transverse section forming a pair of second rivet sections to cooperate with two second mounting holes of two different insulative housings.

8. The electrical connector as claimed in claim 1, wherein each insulative housing forms a plurality of sidewalls to interferentially abut against the lateral walls of the frame.

9. An electrical connector adapted for electrically connecting with at least two chip modules and a printed circuit board, comprising:
at least two insulative housings accommodated with a plurality of contacts therein;
a frame comprising a plurality of lateral walls to define an accommodating space and at least one enhancing rib extending from the lateral wall into the accommodating space of the frame; wherein
the lateral walls of the frame are riveted connected to the insulative housings and the at least enhancing rib is riveted connected to the at least two insulative housings at the same time.

10. The electrical connector as claimed in claim 9, wherein the enhancing rib forms a pair of rivet sections, and wherein each of the at least two insulative housings defines a mounting hole in one side edge adjacent to the enhancing rib to which the rivet section is riveted.

11. The electrical connector as claimed in claim 9, wherein the electrical connector comprises four insulative housings, and wherein the frame forms four enhancing ribs, and wherein each enhancing rib is riveted connected to two insulative housings.

12. The electrical connector as claimed in claim 11, wherein each insulative housing forms a plurality of side edges to locate on the lateral walls and the enhancing ribs of the frame.

13. The electrical connector as claimed in claim 11, wherein each insulative housing is of L-shape.

14. An electrical connector comprising:
an insulative frame including four side walls linked with one another to define a closed confined area, and further including a plurality of ribs extending from the corresponding side walls toward a center of said frame; and
a plurality of insulative housings assembled to the frame corresponding to corresponding areas constituted by said side walls and said ribs, each of said housing including a plurality of peripheral walls commonly defining an upward receiving cavity; wherein
most side portions of each of said housings is protectively laterally hidden behind either the corresponding side wall or the corresponding rib, except some portions thereof facing toward a center of said frame

15. The electrical connector as claimed in claim 14, wherein said most portions are equipped with flanges to stacked under the frame to fasten the housing to the frame while said some portions not.

16. The electrical connector as claimed in claim 14, wherein said some portions are in an right angle manner.
